(19) United States
(12) Patent Application Publication
(10) Pub. No.: US 2026/0078055 A1
(43) Pub. Date: Mar. 19, 2026

(54) METHOD FOR MANUFACTURING GEOPOLYMER CONCRETE COMPONENTS

(71) Applicant: PROTECTGD LLC, Bellevue, NE (US)

(72) Inventors: Hau Trung Tran, Bellevue, NE (US); Nghia Trung Tran, Ho Chi Minh City (VN)

(73) Assignee: PROTECTGD LLC, Bellevue, NE (US)

(21) Appl. No.: 18/889,441

(22) Filed: Sep. 19, 2024

(51) Int. Cl. C04B 12/00; C04B 14/04; C04B 28/00; C04B 40/00; C04B 111/00

(52) U.S. Cl. CPC C04B 12/005; C04B 14/047; C04B 28/006; C04B 40/0082; C04B 2111/00017

(57) ABSTRACT

This invention relates to a method for producing construction components from Geopolymer materials, primarily using fly ash, which can be partially or fully replaced by other materials such as metakaolin, zeolite, rice husk ash, red mud, or industrial by-products. The method involves preparing a mixture of fly ash or Geopolymer materials (80-99.75% by weight), an alkaline activator (0.25-20%), and water (6-30%). The alkaline activator is mixed with water and fly ash to form Geopolymer mortar, which is shaped using methods such as hydraulic pressing, extrusion, rolling, or vibration. The product is cured by drying at temperatures from 60° C. to 250° C. This technology allows for the creation of various construction components, including bricks, panels, pipes, and beams, while enabling the absorption of greenhouse gases like CO2 and CH4, thus promoting environmental protection. Enhancing additives can be included to improve mechanical properties and durability.

### TECHNICAL FIELD

This invention relates to a method for manufacturing semi-dry Geopolymer concrete components using fly ash as the primary raw material. These components include, but are not limited to, bricks, foundation piles, precast concrete panels, drainage pipes, bridge beams, roofing tiles, load-bearing piles, paving stones, wave barriers, coastal and marine protective structures, and bridge piers and utility poles. The manufacturing process is optimized to produce high-strength products with superior load-bearing capacity and environmentally friendly characteristics. This is achieved through a unique manufacturing process that combines pressure pressing, vibration, or vibratory pressing to create components with dense material structures and heat drying to activate the geopolymerization reactions.

Notably, this Geopolymer concrete also has the capability to effectively adsorb and store CO₂, contributing to the reduction of greenhouse gases in the environment. The CO₂ adsorption capability not only helps mitigate adverse climate impacts but also enhances the physical properties of the material, increasing compressive strength and the lifespan of the components. By utilizing industrial waste such as fly ash, this manufacturing method is not only environmentally friendly but also contributes to a circular economy, reduces dependency on natural resources, and offers significant economic benefits.

### BACKGROUND OF THE INVENTION

Currently, fly ash waste from thermal power plants is typically disposed of through landfilling, leading to serious environmental problems such as air pollution caused by the dispersal of fly ash dust and the wastage of land resources for landfill purposes. This not only harms the environment but also incurs significant disposal costs. Additionally, increasingly stringent environmental protection regulations have placed significant pressure on related industries to find more efficient waste management solutions.

Traditional concrete components using Portland cement, a material that generates large amounts of CO2 during production, are responsible for approximately 8% of global CO2 emissions, contributing to climate change. Furthermore, these concrete components are not durable in marine environments due to corrosion by chloride and sulfate ions, leading to short lifespans and high maintenance costs. Population growth and increasing construction demands have put pressure on the supply of building materials while driving the need for sustainable, environmentally friendly construction material solutions.

In this context, the development of alternative materials, such as Geopolymer concrete, has become an urgent need. However, current research and textbooks on Geopolymer concrete production mainly focus on wet mixing technology, where the components are mixed in liquid form and then poured into molds. This method faces several limitations, such as high production costs due to low efficiency and difficulty in fully activating the geopolymerization process at high temperatures due to the high moisture content of the product. When dried at high temperatures, the concrete is prone to cracking, so products are usually dried at temperatures not exceeding 80° C., resulting in incomplete geopolymerization and reduced product quality.

The method of producing Geopolymer fly ash granules according to U.S. Pat. No. 11,629,097 B2 has made significant advances, including steps of mixing fly ash with an alkaline activator, followed by processes such as hydraulic pressing, extrusion, granulation, or briquetting. However, this method primarily focuses on producing granular forms and has not fully exploited the potential of this technology for large-scale concrete component production.

The current invention expands the application of Geopolymer technology by incorporating additional ingredients, including natural aggregates (such as sand, gravel, stones) or artificial aggregates from U.S. Pat. No. 11,629,097 B2, as well as other common aggregates and materials used in the concrete industry, such as steel reinforcement. The use of vibration, vibratory pressing, or centrifugal casting in the formation of Geopolymer concrete components enhances the material's density and bonding, thereby increasing the strength, load-bearing capacity, and lifespan of the products. This invention particularly opens up the possibility of producing components through a more efficient process, reducing costs and being more environmentally friendly.

### SUMMARY OF THE INVENTION

The objective of the present invention is to provide a method for manufacturing construction components from fly ash using semi-dry Geopolymer technology. This method aims to utilize industrial waste (fly ash) to produce high-strength, environmentally friendly concrete components with the ability to adsorb CO2.

The inventors of the present invention surprisingly discovered that by semi-dry mixing fly ash (or fly ash along with aggregates) with an alkaline activator to form a mix, followed by shaping the product using pressure methods such as hydraulic pressing, extrusion, rolling, centrifugal casting, vibration, or vibratory pressing when forming Geopolymer concrete components, it is possible to increase the density and bonding within the material structure. This not only enhances the strength, load-bearing capacity, and extends the product's lifespan but also makes them suitable for various construction applications.

To optimize the production process, the mix can be preheated before shaping to accelerate the geopolymerization process, thereby shortening the production cycle and reducing thermal energy consumption. This method also allows for better control of the component formation process, ensuring that the final product meets technical requirements for hardness and load-bearing capacity.

In some cases, to facilitate the feeding of the mix into shaping molds, especially when the raw fly ash is very light and difficult to handle, the mix can be pre-compacted into suitable pellets before being placed into the mold. This improves the feasibility of the production process and ensures the quality of the final product.

The present invention can also accelerate the geopolymerization process by combining increased pressure with increased temperature during processing, helping the product achieve the necessary initial hardness. This not only allows the product to be safely transported during production but also helps reduce storage and preservation costs.

Based on these discoveries, the present invention has been completed and opens up broad application possibilities in the construction industry, particularly for projects requiring durable and environmentally friendly concrete components.

In the first aspect of the present invention, a method for manufacturing construction components from fly ash is provided, comprising the steps of: (i) preparing materials, including: fly ash in an amount of 80 to 99.75 parts by weight; an alkaline activator in an amount of 0.25 to 20 parts by weight; and water in an amount of 6 to 30% by weight, based on the total weight of the fly ash and alkaline activator; (ii) mixing the alkaline activator with the entire amount of water mentioned above to form an alkaline activator solution, then uniformly mixing this solution with the fly ash to form Geopolymer mortar; (iii) shaping the Geopolymer mortar using a pressure greater than 1 atm, into the desired size and shape, wherein the shaping is performed by methods such as hydraulic pressing, extrusion, rolling, centrifugal casting, vibration, vibration pressing, or a combination thereof as needed; (iv) curing by drying at a temperature of 60° C. to 250° C. to obtain construction components from fly ash.

In one or more embodiments, the Geopolymer mortar can be pelletized for easier feeding into shaping devices such as hydraulic presses, extruders, rolling mills, centrifugal casting machines, vibrating tables, or vibration presses.

In one or more embodiments, the alkaline activator is selected from the group consisting of sodium hydroxide, potassium hydroxide, potassium silicate, sodium silicate, liquid glass, calcium hydroxide, and combinations thereof.

In one or more embodiments, the fly ash is replaced by a mixture of fly ash and aggregate, with the fly ash amounting to not less than 30 parts by weight of the mixture, and the aggregate is selected from the group consisting of sand, gravel, stone, and similar materials.

In one or more embodiments, the fly ash may contain impurities such as mud, and the mixture is adjusted by adding clean fly ash and increasing the alkaline activator to ensure the quality of the Geopolymer material.

In one or more embodiments, the Geopolymer mortar can be preheated at a temperature of 60° C. to 150° C. before being fed into shaping devices such as hydraulic presses, extruders, rolling mills, centrifugal casting machines, vibrating tables, or vibration presses.

In one or more embodiments, drying is performed using resistive heating ovens, gas-fired ovens, infrared ovens, vacuum ovens, autoclaves, convection ovens, solar dryers, microwave ovens, or combinations thereof if necessary.

In one or more embodiments, the alkaline activator is a mixture of sodium hydroxide and water glass, with a weight ratio of sodium hydroxide to water glass (calculated as dry content) ranging from 10/1 to 1/10.

In one or more embodiments, steel reinforcement can be used in the Geopolymer concrete component in a manner similar to that used in conventional Portland concrete.

In one or more embodiments, the Geopolymer mortar can be mixed with enhancing additives such as plasticizers, waterproofing agents, strength enhancers, or reinforcing materials to improve the properties of the final component.

In one or more embodiments, zeolite is mixed into the fly ash mixture in an amount ranging from 5% to 50% by weight of the fly ash, to enhance the mechanical properties and/or CO2 absorption capacity of the Geopolymer concrete component.

In one or more embodiments, the Geopolymer concrete component is capable of absorbing and storing greenhouse gases such as CO2 and CH4 from the environment, contributing to the reduction of greenhouse gas emissions.

In one or more embodiments, wherein the fly ash may be entirely or partially replaced by other materials capable of forming Geopolymer, referred to as Geopolymer materials, including but not limited to metakaolin, zeolite, rice husk ash, red mud, or other industrial by-products.

In the second aspect of the present invention, a method for manufacturing construction products from Geopolymer materials is provided, comprising the steps of: (i) preparing materials, including: Geopolymer materials such as fly ash in an amount of 80 to 99.75 parts by weight; an alkaline activator in an amount of 0.25 to 20 parts by weight; and water in an amount of 6 to 30% by weight, based on the total weight of the fly ash and alkaline activator; (ii) mixing the alkaline activator with the entire amount of water mentioned above to form an alkaline activator solution, then uniformly mixing this solution with fly ash to form Geopolymer mortar; (iii) shaping the Geopolymer mortar to achieve the desired size and shape of the product components, shaping is performed by methods such as hydraulic pressing, extrusion, rolling, centrifugal casting, vibration, or vibration pressing, and molds may be placed on vibrating tables to optimize compaction and product shaping; and (iv) curing by drying at a temperature of 60° C. to 250° C. to obtain construction products from Geopolymer materials.

In the third aspect of the present invention, construction components obtained by the above method are provided, comprising:
(i) heat-resistant and fireproof components made from Geopolymer material that can withstand high temperatures without deforming or losing their mechanical properties, while also prevent the spread of fire in extreme heat environments;
(ii) thermal insulation components, which have the ability to block heat transfer, maintain stable internal temperatures and protect against extreme external heat;
(iii) corrosion-resistant and chemical-resistant components, which can resist corrosion from chemical environments or corrosive agents such as acids, alkalis, seawater, and industrial chemical solutions;
(iv) water filtration components and materials designed to filter and purify water by removing pollutants, heavy metals, or harmful substances;
(v) hazardous gas filtration components and materials, which are used to filter and remove toxic gases or pollutant particles from the air, including industrial emissions; and
(vi) radiation-shielding components and radioactive waste containment, which are capable of blocking or reducing the spread of radiation and can safely contain and handle radioactive waste, wherein the construction products include but are not limited to construction bricks, foundation piles, precast concrete panels, drainage pipes, bridge beams, roofing tiles, load-bearing piles, floor and pavement tiles, wave-blocking panels, coastal and harbor protection structures, bridge pillars and utility poles.

### DETAILED DESCRIPTION OF THE INVENTION

In order to better understand the technical solutions of the present invention, embodiments of the present invention will be described in detail below.

It should be clear that the described embodiments are only some, but not all of the embodiments of the present invention. Based on the embodiments in the present disclosure, all other embodiments obtained by those of ordinary skill in the art without creative efforts fall within the protection scope of the present invention.

In view of the above, some embodiments of the present invention provide a method for manufacturing construction components from fly ash, comprising the following steps:
1. Preparation of Materials:
   Fly Ash: Fly ash is used as the primary material in the production process. It is selected from suitable sources, typically from coal-fired power plants. Fly ash has pozzolanic properties, meaning it can react with alkaline substances to form compounds capable of binding and hardening similar to cement.
   Alkaline Activator: The alkaline activator is used to trigger the geopolymerization reaction in the fly ash. This activator may include sodium hydroxide, potassium hydroxide, or other alkaline compounds, in a ratio of 0.25 to 20 parts by weight relative to the total weight of the fly ash.
   Water: Water is added to the mixture to create the alkaline activator solution, in a ratio of 6 to 30% by weight relative to the total weight of the fly ash and alkaline activator. Water is necessary to ensure sufficient moisture for the geopolymerization reaction and to facilitate the subsequent molding process. The total water content is preferably in the range of 8 to 15%, and more preferably around 10%, by weight of the alkaline activator and fly ash. A water content above 30% is not recommended, as it causes the fly ash mixture to become too slurry and flowable, making it unsuitable for extrusion. Conversely, a lower water content would not adequately wet the fly ash particles, resulting in uneven mixing.
2. Mixing of Materials:
   Alkaline Activator Solution: The alkaline activator is fully dissolved in water to create a homogeneous solution. This solution ensures that the alkaline activator is evenly distributed throughout the fly ash mixture, effectively triggering the geopolymerization reaction.
   Mixing with Fly Ash: The fly ash is thoroughly mixed with the alkaline activator solution. The mixing process must ensure that all fly ash particles are fully coated by the solution, resulting in a homogeneous geopolymer mortar, ready for the molding process.

Mixing Equipment in Geopolymer Production: Mixing equipment plays a crucial role in the production of geopolymer mortar, ensuring the even distribution of the alkaline activator solution throughout the fly ash mixture. The choice of suitable mixing equipment depends on the production scale, material characteristics, and the technical requirements of the final product.

Below are some common mixing equipment options that can be used in the geopolymer production process:
A. Pan Mixer:
   Structure: A pan mixer consists of a cylindrical or conical mixing drum with one or more mixing blades attached to a rotating shaft.
   Advantages: Ensures homogeneity of the mixture by stirring and cutting the material components. Pan mixers are suitable for large batch mixing, helping to evenly distribute the alkaline activator in the fly ash.
   Applications: Commonly used in the production of geopolymer concrete products such as bricks, tiles, and other construction components.
B. Planetary Mixer:
   Structure: A planetary mixer has a system of mixing blades that rotate around the main axis and move in a planetary orbit within the mixing drum.
   Advantages: Creates complex motion of the material components, enhancing mixing uniformity, especially effective for high-viscosity mixtures.
   Applications: Suitable for producing high-quality geopolymer mortar where absolute uniformity in the mixture is required.
C. Continuous Mixer:
   Structure: A continuous mixer uses a screw or conveyor system to mix and transport materials continuously through the mixing drum.
   Advantages: Ensures continuous production with high productivity, suitable for large-scale production processes.
   Applications: Commonly used in the production of large geopolymer components such as wall panels, panels, and tetrapods.
D. Twin-Shaft Mixer:
   Structure: A twin-shaft mixer has two rotating shafts with interlocking blades, creating powerful and efficient mixing motion.
   Advantages: Fast and even mixing capability, reducing mixing time and increasing production efficiency.
   Applications: Suitable for mixing geopolymer mixtures with large aggregates, such as crushed stone, sand, or zeolite.
E. Drum Mixer:
   Structure: A drum mixer has a rotating drum on a horizontal axis, with mixing blades inside the drum to stir the material.
   Advantages: Simple in design and operation, suitable for small to medium-sized batches.
   Applications: Commonly used in laboratories or small production units.
F. Ploughshare Mixer:
   Structure: A ploughshare mixer is an industrial mixer in which plough blades are arranged on a horizontally rotating shaft. These blades can be adjusted in angle and position to optimize the mixing process. The ploughs operate by moving the material within the mixing drum, creating strong and uniform flow throughout the mixture.
   Working Principle: When the mixer's shaft begins to rotate, the ploughs create strong vortices, moving the material particles in various directions, ensuring that all material components are evenly mixed. This process helps distribute the alkaline activator evenly throughout the fly ash while ensuring the geopolymer mortar achieves high uniformity.
   Advantages: The ploughshare mixer is capable of effectively mixing dry and wet materials with short mixing times and consistent results. This is particularly important in geopolymer production, where the uniformity of the mixture directly impacts the quality and mechanical properties of the final product.
   Applications: The ploughshare mixer is suitable for mixing materials such as fly ash, sand, alkaline activators, and other additives in the geopolymer mortar production process. It is often used in processes requiring large-volume material mixing and high uniformity of the mixture.

### Mixing Process:

Step 1: Preparing the Alkaline Activator Solution.
   Dissolving the Alkaline Activator in Water: The alkaline activator is dissolved in water to form a homogeneous solution. This process must be performed carefully to ensure that the alkaline activator is fully dissolved, thereby optimizing the geopolymerization reaction. The dissolution process must be carried out with appropriate safety measures due to the potential heat generation during the process.
Step 2: Mixing the Alkaline Activator Solution with Fly Ash.
   Mixing the Materials: After preparing the alkaline activator solution, it is thoroughly mixed with the fly ash in a suitable mixer to form the geopolymer mortar. The mixing must ensure that all fly ash particles are evenly coated by the alkaline solution, resulting in a homogeneous mortar ready for molding.
Step 3: Proceed with the Subsequent Production Steps.
   Molding and Solidifying: The geopolymer mortar, after being mixed uniformly, is placed into molds to shape the product using methods such as hydraulic pressing, extrusion, rolling, centrifugal casting, vibration, or vibration pressing. The shaped product is then solidified by drying at temperatures ranging from 60° C. to 250° C.
3. Geopolymer Mortar Molding:
   Pressure: The geopolymer mortar is molded using pressure greater than 1 atm (one atmosphere). The pressure helps ensure that the mixture is tightly compacted, removing air and voids, thereby increasing the density and strength of the final product.
   Molding Methods: The molding methods may include hydraulic pressing, extrusion, rolling, centrifugal casting, vibration, or vibration pressing. Depending on the desired final product, these methods can be selected to create components with specific sizes and shapes suitable for construction requirements.

### Description of the Molding Methods:

### A. Hydraulic Pressing:

Working Principle:
   Hydraulic pressing is the process of using a hydraulic piston to generate a large compressive force, tightly compacting the geopolymer mortar within a mold.
   The hydraulic piston operates using fluid (typically hydraulic oil) that is pumped under high pressure, transmitting the compressive force evenly across the entire surface of the geopolymer mortar within the mold.
Process:
   Mold Preparation: The mold is prepared with the desired shape and size for the final product. The mold can be made of steel or a durable alloy to withstand the high pressure during pressing.
   Filling the Mold: The geopolymer mortar is poured into the mold. In some cases, the mortar may be pre-compacted before starting the hydraulic pressing process to ensure even distribution within the mold.
   Pressing: The hydraulic piston applies compressive force to the geopolymer mortar, compacting the material tightly into the mold. This process helps remove voids or air pockets in the mortar, increasing the density and strength of the product.
   Mold Release: After pressing is completed, the product is kept in the mold until it reaches initial hardness. Then, the mold is removed to release the product.
Applications:
   Hydraulic pressing is commonly used to produce components with complex shapes or high precision requirements, such as floor tiles, roofing sheets, or large panels.

### B. Extrusion:

Working Principle:
   Extrusion is the process of pushing the geopolymer mortar through a die (a mold with a specific shape) to produce products with a fixed cross-sectional profile.
   The extruding force can be generated by a piston or screw, which pushes the material through the die under controlled pressure.
Process:
   Extruder Setup: The extruder is set up with a die that has the desired cross-sectional shape and size for the product. The die can be designed to produce items like pipes, beams, or bricks.
   Feeding the Material: The geopolymer mortar is fed into the extrusion chamber, where it is compacted and pushed through the die.
   Extrusion: The geopolymer mortar is extruded through the die under high pressure, creating a continuous strip of material with a fixed shape.
   Cutting the Product: The continuous strip is cut into sections of the desired length, forming the finished products.
   Applications:
      Extrusion is suitable for producing long products with uniform cross-sections such as bricks, pipes, and bridge beams.

### C. Rolling:

Working Principle:
   Rolling is the process of compressing and elongating material through counter-rotating rollers to create a sheet of material with uniform thickness.
   The compressive force is generated by heavy steel or alloy rollers, which compact and flatten the geopolymer mortar.
Process:
   Roller Setup: The rolling machine consists of rollers set at a suitable distance to achieve the desired thickness for the product.
   Feeding the Material: The geopolymer mortar is fed between the rollers, where it is compressed and elongated longitudinally.
   Rolling: The geopolymer mortar is passed through multiple pairs of rollers, each reducing the material's thickness step by step. This process creates a uniform sheet of material.
   Cutting the Sheet: After rolling, the sheet material can be cut to the desired sizes.
Applications:
   The rolling method is commonly used to produce large panels, roofing sheets, or other flat products with uniform thickness.

### D. Centrifugal Casting:

Working Principle:
   Centrifugal casting is the process of using centrifugal force to shape the product inside a rotating mold. The geopolymer mortar is poured into the mold, which is then rotated at high speed, creating pressure that forces the material against the mold walls.
   The centrifugal force ensures even distribution of the geopolymer mortar around the mold's walls, increasing the density and strength of the product.
Process:
   Preparing the Rotating Mold: The rotating mold is prepared with the desired shape, typically for products with circular or cylindrical shapes.
   Filling the Mold: The geopolymer mortar is poured into the rotating mold. The mold is then spun at high speed, helping the material distribute evenly around the mold walls.
   Centrifugal Casting: The geopolymer mortar is spun at high speed, and the centrifugal force presses the material against the mold walls, removing air pockets and increasing material density.
   Mold Release: After spinning and once the material has reached initial hardness, the mold is stopped and the product is removed.
Applications:
   Centrifugal casting is typically used to produce cylindrical or tubular products such as water pipes, electric poles, or other complex-shaped components.

### E. Vibration Molding:

Working Principle:
   Vibration molding refers to the process where the mortar is compacted in the mold using vibrations without applying direct compressive force. When vibrations are applied, the particles in the mortar automatically reposition and compact under the influence of gravity and vibration. This helps the mortar distribute evenly and compact without external force, ensuring the final product is free from voids or internal defects.
Process:
   Mold Preparation: The mold is cleaned and prepared thoroughly before pouring the geopolymer mortar. The mold should be lubricated or coated with a release agent to facilitate easy removal of the product after solidification. The mold can be mounted on a vibrating platform to transmit vibrations more effectively and ensure even vibration throughout the mold.
   Pouring the Mortar: The geopolymer mortar, after being uniformly mixed, is poured gradually into the mold. The pouring process must be carried out carefully to avoid creating voids or gaps inside the mold.
   Applying Vibrations: Vibrations are applied through vibrating devices attached directly to the mold or through the vibrating platform on which the mold is placed. The vibrating devices or platform can be adjusted to generate the appropriate frequency and amplitude of vibrations to ensure the even distribution of the mortar in the mold and the removal of trapped air. Vibrations reduce the viscosity of the mortar, allowing the particles to move freely and settle under gravity and vibration, thereby filling the mold evenly. During vibration, continuous monitoring is required to ensure that there is no segregation of components and that no cracking or shrinkage occurs. Adjusting the frequency and duration of vibrations appropriately ensures optimal compaction.
   Solidification: After the vibration process is complete and the mortar has achieved the desired compaction, the product is left to solidify in the mold.
Applications:
   Vibration molding is suitable for large components like tetrapods, where the mold size is large, and the geopolymer mortar needs to be distributed and filled evenly. Continuous vibrations help eliminate air voids and minimize the formation of internal cavities. This ensures that the final product has a solid structure, free from defects, and has good load-bearing capacity.
   The mold placed on a vibrating platform helps optimize the vibration process, especially for large and heavy products. The vibrating platform can generate uniform vibrations across the entire mold, helping the mortar particles distribute evenly and effectively remove trapped air.
   Vibration is also applied in cases where direct compressive force is difficult or unnecessary, such as when producing large components with complex shapes or when the product requires high uniformity and must be free of internal defects.
   This method is particularly useful for producing products such as tetrapods in coastal protection structures, where the product must withstand strong impacts from seawater and harsh environments.

### F. Vibration Compaction Pressing:

Working Principle:
   Vibration compaction pressing typically refers to the process where the mortar is compacted in the mold under the combined effect of compressive force (hydraulic or mechanical) and vibrations. The compressive force provides direct mechanical pressure on the mortar, while vibrations help the mortar flow and fill the mold, eliminating air bubbles and voids, thereby improving the uniformity and density of the product.
Process:
   Preparing the Mold and Vibrating Press: The mold is placed on a vibrating table or inside a vibrating press, with the frequency and amplitude of vibrations adjusted as needed.
   Filling the Mold: The geopolymer mortar is poured into the mold.
   Vibration Compaction Pressing: Compressive force is applied simultaneously with vibrations, causing the geopolymer mortar to flow and fill the mold while eliminating air bubbles. This process helps create a product with high density and a smooth surface.
   Mold Release: After vibration compaction pressing is complete and the material has reached initial hardness, the product is removed from the mold.
Applications:
   Vibration compaction pressing is commonly used in production processes where high compaction and precise control of the final product shape are required. This process is suitable for products such as concrete bricks, paving blocks, and can be applied to small to medium-sized geopolymer products.

### G. Solidification:

Drying: After forming, the geopolymer components need to be solidified through a drying process at temperatures ranging from 60° C. to 250° C. This drying process helps remove excess moisture and accelerates the geopolymerization process, ensuring that the components achieve the necessary hardness and durability. The drying temperature can be adjusted based on the specific requirements of the product and the desired drying time.

### Advantages of the Process:

Utilization of Recycled Materials: Fly ash, a byproduct of the thermal power industry, is recycled into construction materials, helping to reduce industrial waste and protect the environment.
High-Performance Characteristics: Geopolymer components produced by this method exhibit high durability, excellent water resistance, and superior load-bearing capacity compared to traditional construction materials.
Diverse Applications: This method can be used to produce a wide variety of construction components, from floor tiles, roofing sheets, to load-bearing structures such as bridge beams and columns.

In some embodiments, geopolymer paste can be compressed into pellets before introducing them into shaping equipment such as hydraulic presses, extrusion machines, rolling mills, centrifugal casting, or vibration compaction. This process offers several benefits for the manufacturing process, ensuring the uniformity of the geopolymer paste and optimizing the efficiency of the shaping equipment.

1. Compressing Geopolymer Paste into Pellets:
Purpose of Pelletizing:
   Compressing geopolymer paste into pellets facilitates easier transportation and feeding into shaping equipment.
   Pelletizing ensures material uniformity, which helps the shaping process run smoothly and consistently, avoiding blockages or uneven distribution when pouring the paste directly into the shaping equipment.
Pelletizing Process:
   Preparation of Geopolymer Paste: After the geopolymer paste has been thoroughly mixed as described, it is fed into a pelletizing machine.
   Pelletizing: The pelletizing machine compresses the geopolymer paste into small, uniformly shaped pellets. The size of the pellets can be adjusted according to the requirements of the shaping process and the type of equipment used.
   Storage and Transportation: The pellets can be temporarily stored or transported directly to the shaping equipment. Pelletizing facilitates controlled feeding of the paste into the equipment and ensures there are no unexpected variations in material quantity or quality.
2. Feeding into Shaping Equipment:
   Hydraulic Pressing: The geopolymer pellets can be easily poured into molds before applying hydraulic pressure. The use of pellets ensures that the geopolymer paste is evenly distributed within the mold, avoiding overfilling or underfilling.
   Extrusion: For extrusion processes, pellets can be continuously fed into the extrusion machine, allowing for smooth operation and preventing blockages.
   Rolling: During the rolling process, pellets help maintain material uniformity as it passes through the rollers. This is particularly important to ensure that the rolled material has a consistent thickness.
   Centrifugal Casting: Pellets can be easily dispersed and fed into the centrifugal casting mold, facilitating effective rotation and even material distribution around the mold walls.
   Vibration or Vibration Compaction: In vibration or vibration compaction processes, the use of pellets improves material distribution within the mold, ensuring that the entire mold is filled evenly without gaps or defects.
3. Benefits of Pelletizing:
   Uniformity: Pelletizing ensures a high degree of uniformity in the geopolymer paste before it is introduced into the shaping process. This improves the final product's quality, ensuring that the construction components have stable and durable mechanical properties.
   Optimization of the Production Process: The use of pellets optimizes the feeding process into shaping equipment, minimizing the risk of blockages or equipment malfunctions, thus increasing production efficiency.
   Ease of Transportation and Storage: Pellets are easy to transport and store, reducing waste and enhancing quality control throughout the production process.

In some embodiments, the alkaline activator is selected from the group consisting of sodium hydroxide, potassium hydroxide, potassium silicate, sodium silicate, liquid glass, calcium hydroxide, and combinations thereof.
1. Role of Alkaline Activators in Geopolymer:
   Alkaline activators are a crucial component in the production of Geopolymer concrete, as they initiate the geopolymerization reaction of the aluminosilicate components in fly ash. This process leads to the formation of an inorganic polymer network, imparting strong mechanical properties and high chemical durability to the final product.
2. Selection of Alkaline Activators:
   Below are the types of alkaline activators used:

### A. Sodium Hydroxide (NaOH):

Description: Sodium hydroxide is a strong alkali, commonly used in Geopolymer production due to its easy solubility in water and its ability to create a highly alkaline environment. This facilitates effective chemical reactions with the aluminosilicate in fly ash, leading to the formation of a robust geopolymer structure.
Application: Sodium hydroxide is typically used in applications requiring high strength and resistance to chemical agents, such as load-bearing construction components or waterproofing structures.

### B. Potassium Hydroxide (KOH):

Description: Potassium hydroxide has similar properties to sodium hydroxide but offers higher solubility in water and causes less metal corrosion. It also creates a strong alkaline environment that promotes geopolymerization.
Application: Potassium hydroxide is used where enhanced mechanical strength of the product is required and where resistance to metal corrosion is important, such as in specific industrial applications.
   C. Potassium Silicate (K₂SiO₃) and Sodium Silicate (Na₂SiO₃):
Description: Both potassium silicate and sodium silicate (water glass) are vital alkaline activators, providing both alkali and silicate components, supporting the creation of a geopolymer network with strong bonding properties. The combination of alkali and silicate significantly enhances the mechanical properties and waterproofing ability of the Geopolymer.
Application: Potassium silicate and sodium silicate are commonly used in the production of high-strength, water-resistant construction components, such as panels, non-fired bricks, and high-durability construction elements.

### D. Sodium Silicate Solution (Water Glass):

Description: Sodium silicate solution is a widespread activator in Geopolymer production due to its stability and strong activating ability. It provides both the necessary alkaline environment and silicate for the geopolymerization process, resulting in a stable and durable structure for the final product.
Application: Water glass is often used in applications requiring high heat resistance, strong mechanical properties, and excellent waterproofing, such as in the production of construction bricks, roofing tiles, and load-bearing components.

### E. Calcium Hydroxide (Ca(OH)₂):

Description: Calcium hydroxide, also known as slaked lime, is a weaker alkali compared to sodium hydroxide and potassium hydroxide but can effectively combine with other components in the Geopolymer to enhance mechanical strength and waterproofing ability.
Application: Calcium hydroxide is used in applications that require improved mechanical and chemical properties of the Geopolymer, such as in the production of load-bearing concrete components or products requiring high stability in alkaline environments.

### 3. Combination of Alkaline Activators:

Mixed Alkaline Activators: To achieve optimal mechanical and chemical properties, a combination of alkaline activators can be used. This combination allows for the customization of Geopolymer properties to meet specific application requirements.
Example: A mixture of sodium hydroxide with sodium silicate can create a strong activating environment, significantly enhancing the compressive strength and waterproofing ability of the product. Similarly, combining potassium hydroxide with water glass can produce products with better corrosion resistance and heat tolerance.

### 4. Benefits of Selecting and Combining Alkaline Activators:

Enhanced Geopolymerization Efficiency: The precise selection of alkaline activators helps optimize the geopolymerization process, increasing the durability and chemical resistance of the final product.
Flexibility: Using different alkaline activators or combining them allows for the adjustment and optimization of Geopolymer properties according to specific application needs, creating products suitable for diverse construction and industrial requirements.
Improved Product Quality: Choosing the appropriate alkaline activators not only helps achieve the desired Geopolymer properties but also ensures the final product's quality, minimizing defects and extending product lifespan.

In some embodiments, the production process of construction components can be performed with a mixture of fly ash and aggregate, wherein the alkaline activator is first mixed with the fly ash to form a Geopolymer binder before the aggregate is added to the mixture. The process ensures effective geopolymerization, enhancing the bonding strength and mechanical properties of the final product.

1. Mixing Alkaline Activator with Fly Ash:
Preparation of Fly Ash and Alkaline Activator:
   The fly ash is precisely measured and prepared for mixing with the alkaline activator. The alkaline activator may include sodium hydroxide, potassium hydroxide, sodium silicate, or a combination thereof.
   The alkaline activator solution is prepared with the appropriate amount of water to ensure smooth and even mixing.
Mixing Alkaline Activator with Fly Ash:
The fly ash and alkaline activator solution are thoroughly mixed to activate the geopolymerization process. This process creates the Geopolymer binder, a durable aluminosilicate network that forms the foundation of the mechanical properties of the concrete components.
   The mixing process must be carefully executed to ensure that all fly ash particles participate in the reaction and are fully coated with the alkaline activator.

### 2. Adding Aggregate to the Geopolymer Mixture:

A. Preparation of Aggregate:
   The aggregate may include sand, gravel, or similar materials, selected according to the specific requirements of the final product.
   The aggregate is measured and prepared for mixing into the Geopolymer mixture.
B. Mixing Aggregate with Geopolymer Binder:
   Once the Geopolymer binder has formed, the aggregate is added and thoroughly mixed. This process ensures that the aggregate is fully coated with the Geopolymer binder, creating a homogeneous mixture with high adhesion properties.
   The aggregate plays a crucial role in enhancing the mechanical properties of the product, including compressive strength, toughness, and load-bearing capacity.
   In some cases, to facilitate the production process, fine-grained aggregates like sand may be mixed with the fly ash beforehand. This helps ensure that the sand is evenly distributed within the fly ash, creating a uniform base before the alkaline activator is added.

### 3. Shaping and Curing:

A. Shaping:
   The Geopolymer mixture with the aggregate is then shaped using methods such as hydraulic pressing, extrusion, rolling, centrifugal casting, vibration, or vibration compaction. These methods are detailed above.
   The shaping process helps form the product to the desired size and shape while ensuring that the mixture is compacted, eliminating air pockets and voids.
B. Curing:
   After shaping, the components are dried and cured using one of the previously described drying methods, including electric resistance drying, gas drying, infrared drying, vacuum drying, autoclave drying, convection drying, solar drying, or microwave drying.
   The curing process solidifies the bonds within the Geopolymer structure, producing components with high durability and excellent load-bearing capacity.

### 4. Benefits of the Process:

Ensuring Complete Geopolymerization: Mixing the alkaline activator with fly ash first ensures that the geopolymerization process is fully and effectively completed, creating a strong binder for the concrete components.
Improved Mechanical Strength: Adding aggregate to the Geopolymer binder after the reaction has taken place enhances the adhesion between the components, significantly improving the mechanical strength of the final product.
High Uniformity: This process ensures that the Geopolymer mortar has high uniformity, minimizing the risk of defects or stratification in the final product.
Optimized Production Process: This method also optimizes the production process, reducing the risks associated with shaping and drying while improving product efficiency and quality.

In some embodiments, fly ash containing impurities such as mud is allowed to use in the production of construction components. Fly ash recovered from landfills or dredging processes often contains impurities at levels up to 50%, which may affect the quality and mechanical properties of the product. However, by adjusting the composition of the mixture and using appropriate alkaline activators, it is possible to ensure that geopolymerization proceeds effectively and that the final product meets the required quality standards.

### 1. Composition of Fly Ash Containing Impurities:

Fly ash can contain up to 50% impurities and still be used to produce Geopolymer concrete. In this case, the mud impurities may provide additional fine particles that support the structure formation of the Geopolymer concrete.
Controlling and adjusting the amount of alkaline activator is crucial to compensate for the presence of impurities, ensuring that the necessary reactions still take place fully.
   2. Production Process with Fly Ash Containing 50% Impurities:
A. Preparation of Fly Ash and Alkaline Activator:
   Fly ash containing 50% impurities is analyzed to determine its specific composition and the need for adjustments in the alkaline activator.
   The alkaline activator solution may need to be enhanced, or the mixing time extended to ensure that geopolymerization occurs effectively throughout the mixture.
B. Mixing the Mixture:
   Fly ash containing impurities and the alkaline activator are thoroughly mixed to ensure that the mud particles are uniformly coated by the Geopolymer binder.
   The mixing process must be carefully conducted to ensure homogeneity and prevent the segregation of impurities within the mixture.
C. Shaping and Curing:
   After mixing, the mixture is subjected to shaping using the previously described methods (hydraulic pressing, extrusion, rolling, centrifugal casting, vibration, or vibration compaction) to form the Geopolymer concrete components.
   The components are then dried and cured to complete the production process, with careful control of temperature and drying time to ensure product quality.

### 3. Benefits of Using Fly Ash Containing 50% Impurities:

Maximization of Resource Utilization: A high impurity content of up to 50% allows for maximum use of natural and recycled resources, minimizing waste and environmental impact.
Thorough Waste Processing: Utilizing materials with high impurity content can significantly reduce the amount of waste that needs to be processed, such as sludge from dredging or other industrial waste.

### 4. Example of Specific Adjustments:

Case of Fly Ash Containing 50% Dredged Mud: A mixture comprising 50% dredged mud and 50% fly ash may require a higher amount of alkaline activator to ensure that geopolymerization occurs fully and that the product achieves the desired strength.

In some embodiments, pre-heating the Geopolymer mixture before it is subjected to the shaping process is a crucial technique that enhances the efficiency of the shaping process and improves the quality of the final product. Pre-heating helps to rapidly activate the geopolymerization reaction, reduce the viscosity of the mixture, and facilitate easier shaping.

### 1. Purpose and Benefits of Pre-Heating:

Activation of Geopolymerization Reaction: Pre-heating accelerates the geopolymerization process right before the Geopolymer mixture is introduced into the shaping equipment. This helps reduce the time required for the product to achieve its initial hardness after shaping.
Reduction of Mixture Viscosity: Pre-heating reduces the viscosity of the Geopolymer mixture, allowing it to flow more easily into molds and to be shaped effectively. This is particularly useful when using shaping methods such as extrusion, centrifugal casting, or vibration compaction, where uniform distribution of the mixture within the mold is crucial.
Improvement of Product Surface Quality: The pre-heating process helps eliminate air bubbles and voids that may appear during mixing, thereby improving the surface quality of the final product, resulting in a smoother and more uniform surface.
Acceleration of Production Speed: Pre-heating shortens the shaping and curing times, thereby accelerating production and improving the overall efficiency of the manufacturing process.
Ensuring Even Temperature Distribution Throughout the Product: Particularly for large-volume products, pre-heating ensures that the temperature is evenly distributed throughout the entire volume of the product. This prevents temperature differentials between different parts of the product, reducing the risk of cracking or deformation during shaping and curing.

### 2. Pre-Heating Process for Geopolymer Mixture:

Preparation of the Geopolymer Mixture: The Geopolymer mixture is prepared by mixing fly ash, aggregate (if any), and the alkaline activator according to the steps described in previous sections.
Pre-Heating: After preparation, the Geopolymer mixture is introduced into a heating system. The heating temperature is adjusted between 60° C. to 150° C., depending on the specific requirements of the product and the shaping method being used. This pre-heating process can be conducted using an oven, a resistive heating device, or other suitable heating equipment.
Adjustment of Temperature and Heating Time: The temperature and heating time need to be carefully adjusted to ensure that the mixture does not overheat, which could lead to premature setting before shaping. At the same time, it must be ensured that the temperature is high enough to effectively activate the geopolymerization reaction. Particularly, pre-heating helps to ensure that the temperature is evenly distributed throughout the entire volume of the mixture, especially for large-volume products, helping to prevent temperature differentials that could cause cracking or defects.
Feeding into Shaping Equipment: After pre-heating, the Geopolymer mixture is quickly fed into shaping equipment such as hydraulic presses, extruders, rolling mills, centrifugal casting machines, or vibration compactors. Pre-heating allows the mixture to easily fill the mold and be shaped with high precision.

### 3. Shaping Methods After Pre-Heating:

Hydraulic Pressing: The Geopolymer mixture, after pre-heating, is introduced into molds and subjected to high pressure to form components with the desired shape. Pre-heating improves the compaction and uniformity of the product.
Extrusion: The mixture is fed into an extruder after pre-heating, allowing the product to flow smoothly through the extrusion die and form components with a uniform cross-section.
Rolling: The Geopolymer mixture is passed through rollers to create flat material sheets with uniform thickness. Pre-heating allows the mixture to spread evenly and minimizes defects.
Centrifugal Casting: The mixture is introduced into a centrifugal casting mold after pre-heating, where it is compacted against the mold walls under the action of centrifugal force, forming cylindrical or pipe-shaped components.
Vibration or Vibration Compaction: Pre-heating reduces the viscosity of the mixture, making the vibration or vibration compaction process more effective, ensuring the mixture flows and fills the mold evenly.

### 4. Overall Benefits:

Improved Production Efficiency: Pre-heating improves the overall efficiency of the production process, reduces the time required for shaping and curing steps, and enhances the quality of the final product.
Ensured Uniformity and Strength of the Product: Pre-heating helps ensure that the final product meets standards for uniformity and strength, particularly in applications requiring high mechanical properties and precision.
Even Temperature Distribution: For large-volume products, pre-heating ensures that the temperature is evenly distributed throughout the entire volume of the product, reducing the risk of cracking or deformation due to temperature differentials during drying and curing.

In some embodiments, various drying methods might be used in the production of Geopolymer concrete components. The appropriate use of drying methods is crucial to ensuring that the final product achieves the desired mechanical and chemical properties, as well as ensuring the durability and longevity of the product. Below is a detailed description of each drying method listed.

### 1. Specific Drying Methods:

A. Resistive Heating Oven:
   Operating Principle: The resistive heating oven uses resistance wires to generate heat, providing stable and controllable temperatures. The heat is transferred directly through the air to the components, helping to remove moisture and solidify the Geopolymer mixture.
   Application: Resistive heating ovens are typically used for components that require uniform drying and precise temperature control, such as floor tiles, panels, or small products that demand high precision.
B. Gas-Fired Oven:
   Operating Principle: The gas-fired oven uses the combustion of natural gas or liquefied gas to generate heat. The heat produced is large and even, enabling rapid drying of Geopolymer concrete components.
   Application: Suitable for large components or products that require quick drying, such as large panels, bridge beams, or electric poles.
C. Infrared Oven:
   Operating Principle: The infrared oven uses infrared radiation to directly heat materials from within. Infrared energy penetrates deep into the material, helping to evaporate water from the inside and promote solidification.
   Application: Suitable for thick components or those requiring rapid drying while maintaining a smooth surface quality.
D. Vacuum Oven:
   Operating Principle: The vacuum oven operates by reducing the pressure inside the drying chamber, which lowers the boiling point of water, thus promoting water evaporation without the need for high temperatures. Combined with heating, the vacuum oven effectively dries the product without using high heat.
   Application: Suitable for products that need to maintain mechanical and chemical properties without high drying temperatures, such as special components or products with a high risk of cracking when dried at high temperatures.
E. Autoclave Curing:
   Operating Principle: The autoclave curing method uses high pressure and high temperature to solidify and harden Geopolymer concrete components. This process significantly enhances the strength and load-bearing capacity of the final product.
   Application: Suitable for components that require very high mechanical strength, such as bridge beams, bridge pillars, or other high-load-bearing products.
F. Convection Oven:
   Operating Principle: The convection oven uses hot air circulated by a fan to evenly distribute heat around the Geopolymer concrete components. The temperature can be controlled and maintained throughout the drying process.
   Application: Suitable for products that require uniform and stable drying, such as roofing sheets, floor tiles, or products that require high uniformity.
G. Solar Drying:
   Operating Principle: Solar drying uses heat from sunlight to dry and solidify Geopolymer concrete components. This is an energy-efficient and environmentally friendly method.
   Application: Suitable for small-scale production or in areas with favorable climates with strong and stable sunlight.
H. Microwave Oven:
   Operating Principle: The microwave oven uses microwave energy to heat and dry the product. Microwaves penetrate deep into the material and heat water from within, leading to rapid evaporation.
   Application: Suitable for products that require quick and efficient drying, especially small products or those with low moisture content.

### 2. Overall Benefits of Using Various Drying Methods:

Optimization of the Production Process: The variety of drying methods allows for selecting the most suitable method for the specific requirements of each type of product, optimizing the production process, and ensuring the quality of the final product.
Ensuring Product Quality: Each drying method has its own advantages, helping to ensure that the product achieves the desired mechanical and chemical properties, thereby enhancing the durability, load-bearing capacity, and lifespan of the construction components.
Flexibility in Production: The use of different drying methods allows for flexibility in production, meeting diverse market demands and various production conditions.

### 3. Combining Drying Methods:

Flexible Coordination: In some cases, combining two or more drying methods can yield better results. For example, using a convection oven for preliminary drying and then using an autoclave to complete the solidification process ensures the product achieves maximum mechanical strength.
Specific Application: Combining drying methods can be applied to products with special requirements, such as high-load-bearing components or products that need to be dried quickly and efficiently without compromising quality.

In some embodiments, the alkaline activator is a mixture of sodium hydroxide and water glass, with a weight ratio of sodium hydroxide to water glass (calculated as dry content) ranging from 10/1 to 1/10

### 1. Alkaline Activator:

A. Sodium Hydroxide (NaOH):
   Sodium hydroxide is a strong alkali commonly used to activate the aluminosilicate components in fly ash, promoting the geopolymerization reaction. Sodium hydroxide breaks down the structure of aluminosilicate particles, releasing aluminum and silicon ions necessary for forming bonds in the geopolymer material.
B. Sodium Silicate Solution (Na₂SiO₃):
   Sodium silicate, often referred to as liquid glass, is an alkaline solution containing silica. It is typically used in combination with sodium hydroxide to provide additional silica for the geopolymerization reaction. Sodium silicate not only supplies extra silica but also increases the viscosity of the mixture, helping to control the reaction rate and the structure of the final material.
C. Ratio of Sodium Hydroxide to Sodium Silicate:
   The ratio between sodium hydroxide and sodium silicate can vary depending on the specific product requirements. For example, a 10/1 ratio (NaOH/Na₂SiO₃) creates a strong alkaline environment, suitable for products requiring a high reaction rate and rapid hardening. Conversely, a 1/10 ratio produces a higher viscosity mixture, suitable for products needing longer setting times and better workability.

### 2. Applications of the Alkaline Activator Mixture:

Adjusting Reaction Speed:
   By changing the ratio between sodium hydroxide and sodium silicate, the manufacturer can control the speed of the geopolymerization reaction, thus managing the setting and hardening process of the geopolymer paste. This is especially important when producing large components like tetrapods, where the hardening process needs to proceed slowly to avoid cracking.
Enhancing Mechanical Properties:
   The combination of sodium hydroxide and sodium silicate significantly improves the mechanical properties of the final product, including compressive strength, ductility, and resistance to aggressive environments such as seawater.

In some embodiments, steel reinforcement can be used in the Geopolymer concrete component in a manner similar to that used in conventional Portland concrete.

### 1. Steel Reinforcement in Geopolymer Concrete:

A. Integration of Steel Reinforcement:
   Steel reinforcement is widely used in Portland cement concrete structures to enhance the load-bearing capacity of the components. Similarly, steel reinforcement can be integrated into Geopolymer concrete to provide similar benefits, including increased tensile strength, flexural strength, and resistance to external forces such as wind and earthquakes.
B. Compatibility of Steel Reinforcement with Geopolymer Concrete:
   Geopolymer concrete has an alkaline nature similar to Portland cement, which helps protect the steel reinforcement from corrosion. Additionally, the geopolymerization reaction creates a stable environment that maintains the integrity of the steel reinforcement over time, particularly in harsh environments such as seawater or high-humidity conditions.
C. Specific Applications of Steel Reinforcement:
   Steel reinforcement can be used in various types of Geopolymer concrete products, including bridge beams, columns, foundation piles, and large load-bearing components like tetrapods or wave barriers. The use of steel reinforcement ensures that these products can withstand heavy loads and meet the safety requirements of construction projects.
      2. Production Process with Steel Reinforcement:
A. Preparation of Steel Reinforcement:
   Steel reinforcement is cut and bent to the required dimensions and shapes, then placed into the mold before the Geopolymer paste is poured. In some cases, the steel reinforcement may be treated with anti-corrosion agents before being integrated into the Geopolymer concrete components.
B. Pouring Geopolymer Paste:
   The Geopolymer paste is prepared according to the previous descriptive sections, then poured into the mold containing the steel reinforcement. The paste needs to be evenly distributed around the steel to ensure no voids or gaps exist, which could reduce the mechanical properties of the final product.
C. Molding and Curing:
   The component is molded using methods such as vibration, vibration compaction, or a combination of both. Curing can be done using specialized drying ovens like convection ovens, autoclaves, or other suitable drying methods.

### 3. Benefits of Using Steel Reinforcement:

A. Enhanced Load-Bearing Capacity:
   Integrating steel reinforcement significantly enhances the load-bearing capacity of Geopolymer concrete products, especially in applications that require high strength, such as bridge construction, marine structures, and large load-bearing components.
B. Protection of Steel Reinforcement:
   The alkaline environment of Geopolymer concrete helps protect steel reinforcement from corrosion, ensuring a longer lifespan for structures utilizing this reinforcement.

In some embodiments, Geopolymer mortar can be mixed with enhancing additives such as plasticizers, waterproofing agents, strength enhancers, or reinforcing materials to improve the properties of the final component.

### 1. Additives in Geopolymer Mortar:

A. Plasticizers:
   Plasticizers are additives used to improve the workability and flowability of Geopolymer mortar, making it easier to mold and shape. Plasticizers reduce the amount of water required without compromising the strength of the concrete, thereby enhancing the overall mechanical properties of the final product.
B. Waterproofing Agents:
   Waterproofing agents are additives incorporated to enhance the water resistance of Geopolymer concrete products. This is particularly important for components used in wet environments or those in direct contact with water, such as foundation piles, tetrapods, and wave barriers.
C. Strength Enhancers:
   Strength enhancers can be mineral or polymer-based additives added to increase the compressive, flexural, and tensile strength of the final product. The use of strength enhancers is crucial for products that bear significant loads, such as bridge beams, columns, or other load-bearing components.
D. Concrete Reinforcement Materials:
   Materials such as polymer fibers, glass fibers, or steel fibers can be mixed into the Geopolymer mortar to improve the load-bearing capacity and durability of the final product. The addition of fibers helps prevent cracking and increases the toughness of the components.
      2. Production Process with Additives:
A. Preparing the Mixture:
   Fly ash, aggregates, and additives (plasticizers, waterproofing agents, or strength enhancers) are thoroughly mixed with the alkaline activator solution to form the Geopolymer mortar. The mixing process must ensure that the additives are evenly distributed within the mixture to achieve maximum effectiveness.
B. Molding and Curing:
   Small-sized Products: Bricks, tiles, or similar products will use hydraulic pressing for molding.
   Medium-sized Products: Wall panels, precast panels, or similar components will use extrusion or rolling methods.
   Large-sized Products: Tetrapods, wave-blocking concrete, or large block products will use vibration or vibration compaction methods for molding.
C. After Molding:
   The products are dried at temperatures ranging from 60° C. to 250° C. to cure and achieve the desired mechanical properties.

### 3. Benefits of Using Additives:

A. Improved Mechanical Properties:
   The combination of plasticizers, waterproofing agents, and strength enhancers significantly boosts the mechanical properties of the final product, including compressive strength, water resistance, and flexural strength.
B. Increased Durability and Longevity:
   These additives also help protect the product from harsh environmental factors, extending the overall durability and lifespan of the Geopolymer concrete components.

In some embodiments, zeolite is mixed into the fly ash mixture in an amount ranging from 5% to 50% by weight of the fly ash, to enhance the mechanical properties and/or CO₂ absorption capacity of the Geopolymer concrete component:

### 1. The Role of Zeolite in Geopolymer Mortar:

A. What is Zeolite?
   Zeolite is a group of aluminosilicate minerals with a porous crystalline structure, known for their strong absorption capabilities, including the ability to absorb gases such as CO₂. Zeolite is widely used in various industrial applications due to its unique absorption and ion-exchange properties.
B. Benefits of Adding Zeolite to Geopolymer Mortar:
   CO₂ Absorption Capability: When Zeolite is mixed into Geopolymer mortar, the final product not only serves as a sustainable building material but also possesses the ability to absorb CO₂ from the environment, contributing to the reduction of greenhouse gas emissions.
   Enhanced Mechanical Properties: Zeolite can significantly improve the mechanical properties of Geopolymer concrete products, including increased compressive strength, flexural strength, and water resistance.

### 2. Zeolite Proportion in the Mixture:

A. Optimal Zeolite Ratio:
   The proportion of Zeolite in the Geopolymer mortar can range from 5% to 50% by weight of the fly ash. This ratio depends on the specific requirements for the mechanical properties and CO₂ absorption capability of the product. For instance, a lower Zeolite ratio may be used when the priority is to enhance compressive strength, while a higher ratio may focus on maximizing CO₂ absorption.
      3. Production Process with Zeolite:
A. Preparing the Mixture:
   Fly ash and Zeolite are thoroughly mixed, and this mixture is then combined with the alkaline activator solution to form the Geopolymer mortar. The mixing process must ensure that the Zeolite is evenly distributed throughout the mixture.
B. Molding and Curing:
   Small-sized Products: Bricks, tiles, or similar products will use hydraulic pressing for molding.
   Medium-sized Products: Wall panels, precast panels will use extrusion or rolling methods.
   Large-sized Products: Tetrapods, wave-blocking concrete, or large block products will use vibration or vibration compaction methods.
C. After Molding:
   The products are dried at temperatures ranging from 60° C. to 250° C. to cure and achieve the desired mechanical properties.

### 4. Benefits of Using Zeolite:

A. Enhanced CO2 Absorption Capability:
   The presence of Zeolite allows the Geopolymer material to absorb CO₂, turning the final product into an effective tool for reducing greenhouse gas emissions in construction projects.
B. Improved Mechanical Properties and Durability:
   Zeolite not only enhances mechanical strength but also helps protect the product from environmental degradation, such as seawater intrusion, due to its absorption and water-resistant properties.

In some embodiments, the Geopolymer concrete component is capable of absorbing and storing greenhouse gases such as CO₂ and CH₄ from the environment, contributing to the reduction of greenhouse gas emissions.

### 1. Greenhouse Gas Absorption and Retention Capabilities of Geopolymer Materials:

What are Greenhouse Gases?
   Greenhouse gases, including CO₂ (carbon dioxide) and CH₄ (methane), are gases capable of trapping heat in the atmosphere, causing the greenhouse effect and leading to climate change. Reducing the amount of greenhouse gases in the atmosphere is one of the key objectives for environmental protection and combating climate change.
The Role of Geopolymer Materials in Absorbing Greenhouse Gases:
   Geopolymer materials, especially when supplemented with substances like Zeolite, have the ability to absorb and retain greenhouse gases such as CO₂ and CH₄. The porous structures of Geopolymer and Zeolite allow them to absorb these gas molecules from the environment and trap them within the material's structure, helping to reduce the amount of greenhouse gases released into the atmosphere.
   Geopolymer materials can absorb CO₂ through chemical reactions between CO₂ and the active surface components of the material. CO₂ from the air or seawater can react with hydroxyl groups (OH—) and alkali metal ions in the Geopolymer to form stable carbonate salts. This process can be described by the following chemical reactions:
      A. CO2 Absorption from Air:

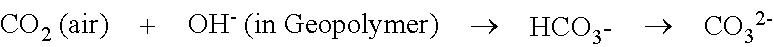

B. CO2 Retention:

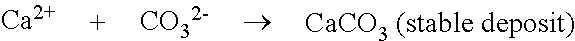

This absorption and retention process helps Geopolymer not only reduce greenhouse gases like CO₂ in the environment but also improves the stability and durability of the final structure.
Benefits of Greenhouse Gas Absorption Capabilities:
   Integrating greenhouse gas absorption and retention capabilities into construction components made from Geopolymer concrete contributes to sustainable construction and enables buildings to act as carbon sinks, thereby supporting environmental protection and climate change mitigation goals.
      2. Production Process with Greenhouse Gas Absorption Capability:
Preparing the Mixture:
   Fly ash and Zeolite (or other additives with greenhouse gas absorption capabilities) are thoroughly mixed, and this mixture is then combined with the alkaline activator solution to form Geopolymer mortar. The mixing process must ensure that the additives are evenly distributed within the mixture to optimize the absorption of greenhouse gases.
Molding and Curing:
   Small-sized Products: Bricks, tiles, or similar products will use hydraulic pressing for molding.
   Medium-sized Products: Wall panels, precast panels will use extrusion or rolling methods.
   Large-sized Products: Tetrapods, wave-blocking concrete, or large block products will apply vibration or vibration compaction methods.
After Molding:
   The products are dried at temperatures ranging from 60° C. to 250° C. to cure and ensure uniformity throughout the entire structure.

### 3. Benefits of the Method:

Reducing Greenhouse Gas Emissions:
   Geopolymer concrete components with the ability to absorb and retain CO2 and CH₄ help reduce the amount of greenhouse gases emitted into the environment, turning construction projects into effective “carbon sinks.”
Enhancing Sustainable Value of Buildings:
   Using Geopolymer materials with greenhouse gas absorption capabilities in construction not only improves the environmental performance of buildings but also enhances their sustainable value, contributing to sustainable development goals.

In some embodiments, fly ash may be entirely or partially replaced by other materials capable of forming Geopolymer, referred to as Geopolymer materials, including but not limited to metakaolin, zeolite, rice husk ash, red mud, or other industrial by-products.

1. Types of Geopolymer Materials that Can Be Used:
Metakaolin: A common raw material capable of forming Geopolymer with high mechanical properties and good heat resistance. Metakaolin is often used to enhance the strength and durability of Geopolymer products.
Zeolite: Zeolite is a mineral with a unique microporous structure, allowing it to absorb gases such as CO₂ and improve the physical properties of Geopolymer materials.
Rice Husk Ash: Rice husk ash is an agricultural byproduct capable of forming Geopolymer when combined with an alkaline activator. Rice husk ash enhances the sustainability of the product by using renewable resources.
Red Mud: Red mud is an industrial waste from aluminum production that can be used in Geopolymer production to minimize environmental impact and recycle waste.
Other Industrial Byproducts:
   2. Production Process with Geopolymer Materials:
Preparing the Raw Materials: Geopolymer materials such as fly ash, metakaolin, zeolite, or industrial byproducts are prepared in appropriate proportions, ensuring the necessary chemical properties for the geopolymerization process.
Dissolving the Alkaline Activator: The alkaline activator is dissolved in water to form a solution, which is then thoroughly mixed with the prepared Geopolymer material.
Molding: The Geopolymer mixture is placed into molds and shaped using methods such as hydraulic pressing, extrusion, rolling, centrifugal casting, vibration, or vibration compaction.
Curing: The products are cured by drying at temperatures ranging from 60° C. to 250° C., completing the geopolymerization process and achieving the desired mechanical properties.

### 3. Benefits and Applications:

Flexibility in Production: Allowing the use of various materials to form Geopolymer enhances production flexibility, optimizing raw material costs and utilizing available resources.
Environmental Protection: Using industrial byproducts and recycled materials helps minimize environmental impact and provides a sustainable solution for the construction industry.
Diverse Product Range: Different Geopolymer materials can produce products with diverse properties, suitable for various applications in construction, from bricks, precast panels, to large load-bearing structures like bridge beams and columns.

Some embodiments of the present invention further provide a method for producing construction products from Geopolymer materials, comprising the following steps:

### 1. Material Preparation:

Geopolymer Materials:
   Fly ash or other Geopolymer materials are used as the primary component of the Geopolymer mortar, constituting 80% to 99.75% by weight of the mixture. Fly ash can be clean or contain impurities such as mud, depending on its source and collection conditions. In cases where fly ash is substituted with other Geopolymer materials (such as metakaolin, zeolite, rice husk ash, red mud), the usage ratio may be similar.
Alkaline Activator:
   The alkaline activator is used in amounts ranging from 0.25% to 20% by weight of the mixture. Alkaline activators such as sodium hydroxide, potassium hydroxide, sodium silicate, potassium silicate, liquid glass, calcium hydroxide, or a combination thereof play a crucial role in activating the geopolymerization process, forming durable bonds within the material.
Water:
   Water is added in amounts ranging from 6% to 30% by weight of the Geopolymer material and alkaline activator mixture. It helps dissolve the alkaline activator and ensures that the geopolymerization process occurs efficiently.

### 2. Mixing the Materials:

Alkaline Activator Solution:
   The alkaline activator is fully dissolved in water to create a homogeneous solution. This solution ensures that the alkaline activator is evenly distributed throughout the entire Geopolymer material mixture, effectively triggering the geopolymerization process.
Mixing with Geopolymer Materials:
   The alkaline activator solution is thoroughly mixed with the Geopolymer material to form a consistent Geopolymer mortar, ready for shaping. Mixing can be performed using mixers such as forced mixers, horizontal shaft mixers, or plowshare mixers to ensure the homogeneity of the mixture.

### 3. Shaping Geopolymer Products:

Shaping Methods:
   The Geopolymer mortar, after mixing, is introduced into molds to shape the products. The shaping methods can include:
      Hydraulic Pressing: Applying high pressure to compress the Geopolymer mortar into molds, producing products such as bricks, paving stones, and tiles.
      Extrusion: The Geopolymer mortar is extruded through shaping molds, suitable for manufacturing products like precast panels and drainage pipes.
      Rolling: Applying rolling force to shape the Geopolymer mortar into sheets, suitable for producing roofing tiles and wall panels.
      Centrifugal Casting: Using centrifugal force to shape the product, suitable for components such as bridge piles, utility poles, and drainage pipes.
      Vibration and Vibration Compaction: Using vibration or a combination of vibration and pressing force to compact and shape the product, suitable for large or complex products such as tetrapods, wave-blocking structures, and coastal and harbor protection components.
Molds Mounted on Vibration Tables:
   For large or complex-shaped products such as tetrapods, molds can be mounted on vibration tables to optimize the compaction and shaping process.

### 4. Curing and Drying the Products:

Curing Process:
   After shaping, the Geopolymer products are cured by drying at temperatures ranging from 60° C. to 250° C. The drying process helps remove excess moisture, promotes the completion of the geopolymerization process, and ensures the strength and durability of the products.
Preheating:
   In some cases, the Geopolymer mortar can be preheated at temperatures between 60° C. and 150° C. before being introduced into the mold. This ensures uniform temperature distribution throughout the entire product volume, particularly for large products such as bridge piles, tetrapods, and coastal protection structures.

In some embodiments, construction components produced from Geopolymer materials through the method described in previous parts are provided. Specifically, these components meet several technical requirements, including:

### 1. Heat-Resistant and Fireproof Components:

Mechanism: Geopolymer possesses high thermal resistance due to its strong bond structure between aluminum and silicon ions, allowing it to retain mechanical properties even when exposed to temperatures of up to 1000° C. This makes it a highly safe building material in environments prone to fire hazards.
Application: Fire-resistant walls, partitions, heat-resistant panels, and protective structures against fire hazards.

### 2. Thermal Insulation Components:

Mechanism: The microporous structure of Geopolymer reduces thermal conductivity. The high insulation capability of these components helps maintain stable internal temperatures while preventing heat from the external environment from penetrating inside.
Application: Insulation panels for homes, warehouses, and industrial plants where high thermal insulation is required.

### 3. Corrosion-Resistant and Chemical-Resistant Components:

Mechanism: Geopolymer resists chemical agents such as acids, alkalis, and seawater, as it does not degrade or corrode in harsh environments. This gives it a significant advantage for outdoor structures or those exposed to chemicals.
Application: Construction components for marine environments, chemical plants, and industrial applications requiring high corrosion resistance.

### 4. Water Filtration Components and Materials:

Mechanism: Geopolymer's microporous structure and ion exchange properties enable it to absorb and trap contaminants in water, filtering out heavy metals and toxic substances.
Application: Water filtration systems, wastewater treatment components, and structures used for purifying drinking or industrial water.

### 5. Hazardous Gas Filtration Components and Materials:

Mechanism: Geopolymer can absorb toxic gases or fine particles in the air through its porous structure and chemical interaction with gases such as SOx, NOx, and CO₂. This makes it effective for filtering industrial emissions and cleaning the air in toxic environments.
Application: Industrial gas filters, ventilation systems, and air filtration devices in factories.

### 6. Radiation-Shielding Components and Radioactive Waste Containment:

Mechanism: Geopolymer can absorb and immobilize radioactive ions due to its porous structure and durable aluminosilicate network. This helps trap radioactive ions such as Cesium (Cs), Strontium (Sr), and Uranium (U) within the material structure, preventing their release into the environment.
Application: Components used for radiation protection in nuclear plants, radioactive waste storage facilities, and nuclear waste treatment systems.

Specific products described include:
Construction bricks: Produced from Geopolymer, these bricks provide heat resistance and fireproofing to protect construction projects.
Foundation piles: Heat-resistant and corrosion-resistant piles used in industrial or outdoor projects.
Precast concrete panels: Insulating or load-bearing panels suitable for projects requiring high technical performance.
Drainage pipes: Chemical-resistant pipes used in wastewater treatment systems or industrial zones.
Bridge beams: Fireproof and corrosion-resistant beams to increase the durability of bridge structures.
Roofing tiles: Insulating, fireproof tiles for residential or public buildings.
Load-bearing piles: Piles made from Geopolymer with radiation resistance or used for handling nuclear waste.
Floor and pavement tiles: Insulating or chemical-resistant tiles for industrial and commercial projects.
Wave-blocking panels: Corrosion-resistant panels used in coastal and harbor protection projects.
Coastal and harbor protection structures: Abrasion-resistant, erosion-resistant components for use in coastal and harbor projects.
Bridge pillars and utility poles: Load-bearing, corrosion-resistant, and chemical-resistant pillars and poles ensuring the durability of infrastructure projects.

Overall benefits: Geopolymer products described above can be used in various industrial and specialized construction applications. These products not only offer heat resistance and corrosion protection but also provide solutions for environmental challenges such as gas filtration, water filtration, and radioactive waste management, addressing the growing demand for sustainable and environmentally friendly solutions.

### EXAMPLES

### Example 1

### Production of Construction Bricks by Hydraulic Pressing

Process:
   Material Preparation: Fly ash is mixed with an alkaline activator (sodium hydroxide) and water at a ratio of 90% fly ash, 5% sodium hydroxide, and 15% water.
   Mixing: The alkaline activator solution is thoroughly mixed with the fly ash to form Geopolymer mortar.
   Shaping: The Geopolymer mortar is pressed in molds using a hydraulic press at a pressure of 10 MPa to shape standard-sized bricks.
   Curing: The bricks are then dried at 200° C. for 24 hours to achieve a minimum compressive strength of 40 MPa.
   Result: The bricks produced have high strength, water resistance, and can withstand harsh environmental conditions.

### Example 2

### Production of Pavement Tiles by Vibration

Process:
   Material Preparation: A mixture of fly ash and sand (70% fly ash, 30% sand) is mixed with an alkaline activator (sodium silicate) and water.
   Mixing: The alkaline activator solution is mixed with the fly ash and sand mixture to create Geopolymer mortar.
   Shaping: The mortar is poured into molds on a vibrating table to compact the mixture, forming pavement tiles with dimensions of 300×300×50 mm.
   Curing: The tiles are dried at 180° C. for 12 hours, achieving a compressive strength of 35 MPa.
Result: The pavement tiles produced have high durability, good load-bearing capacity, and effective water resistance.

### Example 3

Production of Floor Tiles with Waterproof Additives
Process:
   Material Preparation: Fly ash (80%) is mixed with zeolite (10%) and waterproof additives (10%), combined with an alkaline activator (potassium silicate) and water.
   Mixing: The mixture is thoroughly blended to form Geopolymer mortar.
   Shaping: The mortar is hydraulically pressed in molds at a pressure of 12 MPa to create floor tiles with dimensions of 400×400×20 mm.
   Curing: The tiles are dried at 150° C. for 24 hours, achieving a compressive strength of 45 MPa.
Result: The floor tiles produced have excellent waterproofing properties, a smooth surface, and high durability.

### Example 4

### Production of Precast Panels by Extrusion

Process:
   Material Preparation: A mixture of fly ash (85%), artificial sand (10%), and polymer fibers (5%) is mixed with an alkaline activator (sodium silicate) and water.
   Mixing: The alkaline activator solution is thoroughly mixed with the fly ash, sand, and polymer fiber mixture to create Geopolymer mortar.
   Shaping: The mortar is fed into an extrusion machine to form precast panels with dimensions of 1200×600×50 mm.
   Curing: The panels are dried at 190° C. for 18 hours, achieving a compressive strength of 50 MPa.
Result: The precast panels produced have high mechanical strength, fire resistance, and good load-bearing capacity.

### Example 5

### Production of Tetrapods by Vibration

Process:
   Material Preparation: Fly ash (60%) is combined with red mud (20%) and steel fibers (20%), mixed with an alkaline activator (sodium hydroxide) and water.
   Mixing: The alkaline activator solution and water are thoroughly mixed with the fly ash, red mud, and steel fibers.
   Shaping: The Geopolymer mortar is poured into large molds on a vibrating table with embedded steel reinforcement to compact and shape tetrapods weighing 5 tons.
   Curing: The tetrapods are dried in a gas-fired oven at 250° C. for 48 hours, achieving a compressive strength of 60 MPa.
Result: The tetrapods produced have high mechanical strength, corrosion resistance, and good load-bearing capacity in marine environments.

### Example 6

### Production of Coastal Protection Structures by Centrifugal Casting

Process:
   Material Preparation: Fly ash (70%) is combined with metakaolin (20%) and glass fibers (10%), mixed with an alkaline activator (sodium silicate) and water.
   Mixing: The alkaline activator solution is thoroughly mixed with the fly ash, metakaolin, and glass fibers to create Geopolymer mortar.
   Shaping: The Geopolymer mortar is poured into a centrifugal casting mold to form coastal protection structures with a thickness of 150 mm.
   Curing: The structures are dried at 200° C. for 36 hours, achieving a compressive strength of 55 MPa.
Result: The coastal protection structures produced have good load-bearing capacity, water resistance, and can withstand the impact of ocean waves.

What is claimed is:

1. A method for producing construction components from fly ash, comprising the steps of:
(i) preparing materials, including: fly ash in an amount of 80 to 99.75 parts by weight; an alkaline activator in an amount of 0.25 to 20 parts by weight; and water in an amount of 6 to 30% by weight, based on the total weight of the fly ash and alkaline activator;
(ii) mixing the alkaline activator with the entire amount of water mentioned above to form an alkaline activator solution, then uniformly mixing this solution with the fly ash to form Geopolymer mortar;
(iii) shaping the Geopolymer mortar using a pressure greater than 1 atm, into the desired size and shape, wherein the shaping is performed by methods such as hydraulic pressing, extrusion, rolling, centrifugal casting, vibration, vibration pressing, or a combination thereof as needed;
(iv) curing by drying at a temperature of 60° C. to 250° C. to obtain construction components from fly ash.

2. The method for producing construction components from fly ash as claimed in claim 1, wherein the Geopolymer mortar can be pelletized for easier feeding into shaping devices such as hydraulic presses, extruders, rolling mills, centrifugal casting machines, vibrating tables, or vibration presses.

3. The method for producing construction components from fly ash as claimed in claim 1, wherein the alkaline activator is selected from the group consisting of sodium hydroxide, potassium hydroxide, potassium silicate, sodium silicate, liquid glass, calcium hydroxide, and combinations thereof.

4. The method for producing construction components from fly ash as claimed in claim 1, wherein the fly ash is replaced by a mixture of fly ash and aggregate, with the fly ash amounting to not less than 30 parts by weight of the mixture, wherein the aggregate is selected from the group consisting of sand, gravel, stone, and similar materials.

5. The method for producing construction components from fly ash as claimed in claim 1, wherein the fly ash may contain impurities such as mud, and the mixture is adjusted by adding clean fly ash and increasing the alkaline activator to ensure the quality of the Geopolymer material.

6. The method for producing construction components from fly ash as claimed in claim 1, wherein the Geopolymer mortar can be preheated at a temperature of 60° C. to 150° C. before being fed into shaping devices such as hydraulic presses, extruders, rolling mills, centrifugal casting machines, vibrating tables, or vibration presses.

7. The method for producing construction components from fly ash as claimed in claim 1, wherein drying is performed using resistive heating ovens, gas-fired ovens, infrared ovens, vacuum ovens, autoclaves, convection ovens, solar dryers, microwave ovens, or combinations thereof as needed.

8. The method for producing construction components from fly ash as claimed in claim 1, wherein the alkaline activator is a mixture of sodium hydroxide and water glass, with a weight ratio of sodium hydroxide to water glass (calculated as dry content) ranging from 10/1 to 1/10.

9. The method for producing construction components from fly ash as claimed in claim 1, wherein steel reinforcement can be used in the Geopolymer concrete component in a manner similar to that used in conventional Portland concrete.

10. The method for producing construction components from fly ash as claimed in claim 1, wherein the Geopolymer mortar can be mixed with enhancing additives such as plasticizers, waterproofing agents, strength enhancers, or reinforcing materials to improve the properties of the final component.

11. The method for producing construction components from fly ash as claimed in claim 1, wherein zeolite is mixed into the fly ash mixture in an amount ranging from 5% to 50% by weight of the fly ash, to enhance the mechanical properties and/or CO₂ absorption capacity of the Geopolymer concrete component.

12. The method for producing construction components from fly ash as claimed in claim 1, wherein the Geopolymer concrete component is capable of absorbing and storing greenhouse gases such as CO₂ and CH₄ from the environment, contributing to the reduction of greenhouse gas emissions.

13. The method for producing construction components from fly ash as claimed in claim 1, wherein the fly ash may be entirely or partially replaced by other materials capable of forming Geopolymer, referred to as Geopolymer materials, including but not limited to metakaolin, zeolite, rice husk ash, red mud, or other industrial by-products.

14. A method for producing construction products from Geopolymer materials as claimed in claim 13, comprising the steps of:
(i) preparing materials, including: Geopolymer materials such as fly ash in an amount of 80 to 99.75 parts by weight; an alkaline activator in an amount of 0.25 to 20 parts by weight; and water in an amount of 6 to 30% by weight, based on the total weight of the fly ash and alkaline activator;
(ii) mixing the alkaline activator with the entire amount of water mentioned above to form an alkaline activator solution, then uniformly mixing this solution with fly ash to form Geopolymer mortar;
(iii) shaping the Geopolymer mortar to achieve the desired size and shape of the product components, wherein shaping is performed by methods such as hydraulic pressing, extrusion, rolling, centrifugal casting, vibration, or vibration pressing, and wherein molds may be placed on vibrating tables to optimize compaction and product shaping;
(iv) curing by drying at a temperature of 60° C. to 250° C. to obtain construction products from Geopolymer materials.

15. Construction components produced by the method as claimed in claim 14, including:
(i) heat-resistant and fireproof components made from Geopolymer material that can withstand high temperatures without deforming or losing their mechanical properties, while also prevent the spread of fire in extreme heat environments;
(ii) thermal insulation components, which have the ability to block heat transfer, maintain stable internal temperatures and protect against extreme external heat;
(iii) corrosion-resistant and chemical-resistant components, which can resist corrosion from chemical environments or corrosive agents such as acids, alkalis, seawater, and industrial chemical solutions;
(iv) water filtration components and materials designed to filter and purify water by removing pollutants, heavy metals, or harmful substances;
(v) hazardous gas filtration components and materials, which are used to filter and remove toxic gases or pollutant particles from the air, including industrial emissions; and
(vi) radiation-shielding components and radioactive waste containment, which are capable of blocking or reducing the spread of radiation and can safely contain and handle radioactive waste,
wherein the construction products include but are not limited to:
construction bricks,
foundation piles,
precast concrete panels,
drainage pipes,
bridge beams,
roofing tiles,
load-bearing piles,
floor and pavement tiles,
wave-blocking panels,
coastal and harbor protection structures,
bridge pillars and utility poles.
